(19) United States
(12) Patent Application Publication
(10) Pub. No.: US 2009/0280381 A1
(43) Pub. Date: Nov. 12, 2009

(54) Diatomaceous Earth Proton Conductor

(75) Inventor: Bo Wang, Lompoc, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: World Minerals, Inc., Santa Barbara, CA (US)

(21) Appl. No.: 12/307,729

(22) PCT Filed: Jun. 29, 2007
(86) PCT No.: PCT/US07/72518

§ 371 Date: Mar. 10, 2009

Related U.S. Application Data
(60) Provisional application No. 60/819,102, filed on Jul. 7, 2006.

(51) Int. Cl. H01G 9/032; H01M 8/10; G01N 27/00

(52) U.S. Cl. 429/33; 422/98; 252/62.2

(57) ABSTRACT

Diatomaceous earth (“DE”) proton conductors are disclosed for use as electrolytes in electrochemical applications, such as fuel cells, gas sensors, humidity sensors, and pH sensors. The DE proton conductors may be formed by, for example, cutting from diatomaceous crude, pressing diatomaceous powder into pellets, or any other suitable shape-forming methods. In electrochemical applications, the DE proton conductor may be used to separate a hydrogen anode from an oxygen cathode and may conduct protons generated at the hydrogen anode to the oxygen cathode.

This international PCT application claims priority to U.S. Provisional Patent Application No. 60/819,102, filed Jul. 7, 2006, which is incorporated by reference herein in its entirety.

### DESCRIPTION OF THE INVENTION

1. Field of the Invention

Disclosed herein is a diatomaceous earth (“DE”) proton conductor for fuel cells and other electrochemical applications. For example, disclosed herein are solid state DE proton conductors that may serve as electrolytes for fuel cells and other electrochemical applications, such as gas sensors, humidity sensors, and pH sensors. Also disclosed herein is the use of DE as a proton conductive filler in a polymer membrane.

2. Background of the Invention

A solid state proton conductor is an electrolyte in which protons or hydrogen ions are the primary charge carriers. Solid state proton conductors may be composed of polymers or ceramics having small pores. The small pores may prevent larger negative ions from passing through the proton conductor while allowing smaller ions, such as positive hydrogen ions or protons, to flow through the material.

Solid state proton conductors have been commercially implemented in fuel cells, such as fuel cells serving in internal combustion engines in vehicles, to conduct protons between electrodes. Solid state proton conductors have also been utilized in other electrochemical applications, such as gas sensors and humidity sensors. One alternative to solid state proton conductors, liquid electrolytes, may be difficult to implement as self-supporting components and, due to their often highly corrosive nature, it may be difficult to contain them so as not to cause damage to the surrounding elements. Currently known solid state proton conductors may overcome some of the problems associated with liquid electrolytes, as they may be capable of holding their own structures, and they may be stable and non-corrosive with some electrode materials. However, these known solid state proton conductors may often be reactive with many common base metals such as zinc, aluminum, and iron, which may be used in electrochemical cells. Moreover, some known solid state proton conductors, such as those disclosed, for example, in U.S. Pat. No. 4,495,078 to Bell et al. and U.S. Pat. No. 4,513,069 to Kreuer et al., may be highly radioactive and/or highly toxic, such that they must be carefully handled, packaged, and installed to prevent contamination, for example in consumer products.

Solid state proton conductors used as electrolytes may take the form of, for example, thin membranes or hydrated oxides. U.S. Pat. Nos. 7,029,559 to Won et al. and 5,919,583 to Grot et al., for example, disclose proton conductive membranes for use in fuel cells.

Proton conductivity of some solid state proton conductors may be very low in their dry state. However, as the level of hydration increases, the proton conductivity of such solid state proton conductors may increase. For example, proton conductors, when placed in a wet state, may exhibit sufficient proton conductivity for use in fuel cells or other electrochemical applications at a temperature of about room temperature (about 22° C.).

Furthermore, solid state proton conductors in the form of metal oxides may exhibit proton conductivity without the use of moisture as a migration medium. For example, in the proton conductor disclosed in U.S. Pat. No. 6,994,807 to Tanner, a perovskite structure is present. In the perovskite structure, the protons are not present initially in the metal oxide, but may be introduced when the perovskite structure contacts the steam of an atmospheric gas. For example, water molecules may react with oxygen deficient portions in the perovskite structure at a high temperature to generate protons. In this way, the protons may be conducted while being singly channeled between oxygen ions forming a skeleton of the perovskite structure.

While the above proton conductors may function, the cost of integrating them into suitable electrochemical applications may be relatively high. Accordingly, a need exists for a lower cost proton conductor that may be capable of achieving high proton conductivity and is associated with minimum reactivity and toxicity.

Diatomaceous earth (“DE”) is a naturally-occurring product. DE may take the form of a soft, chalk-like, sedimentary rock that is enriched in biogenic silica formed from the siliceous frustules (i.e., shells or skeletons) of water-born diatoms. These diatoms include a diverse array of microscopic, single-celled algae of the class Bacillariophyceae, which possess ornate siliceous frustules of varied and intricate structure comprising two valves that may fit together much like a pill box in the living diatom. The surface of each valve may be punctuated by a series of openings that comprise a complex fine structure of frustules, which may range in diameter from 0.75 to 1,000 μm, such as from 10 to 150 μm. Because many of the frustules may be sufficiently durable to retain much of their porous and intricate structure through long periods of geologic time when preserved in conditions that maintain chemical equilibrium, DE formed from the remains of diatoms may be finely porous, have low density, and be essentially chemically inert in most liquids and gases. The porous structure of silica in DE creates networks of void spaces that may be capable of absorbing a high concentration of water and may allow DE to be crumbled into a fine, whitish, abrasive powder. Due to DE's high porosity and abrasive properties, DE products have been used commercially as, for example, filtration aids, mild abrasives, mechanical insecticides, absorbents for liquids, cat litters, and insulators. Moreover, DE is capable of absorbing a high concentration of water, which may result in fast proton conduction.

The present inventor has discovered and disclosed herein that DE's fine porosity may be ideal for proton conduction, for example in fuel cells and other electrochemical applications. DE is also nontoxic, non-corrosive, and non-radioactive, making it suitable for use with metal components in electrochemical applications using solid state proton conductors. Furthermore, DE is formed from the remains of water-born diatoms and thus may be abundantly available in proximity to either current or former bodies of water. This abundance translates to a relatively low material cost when compared to those materials that are currently being used as proton conductors.

### SUMMARY OF THE INVENTION

It is to be understood that both the foregoing general description and the following detailed description are exemplary and explanatory only and are not restrictive of the invention as claimed. The foregoing background and summary are not intended to provide any independent limitations on the claimed invention.

As disclosed herein, natural diatomaceous earth products may be configured as proton conductors for fuel cells and other electrochemical applications, including, for example, humidity sensors, gas sensors, and pH sensors. The DE proton conductors used in such applications may exhibit high proton conductivity at room temperature due to their unique porous structures. In certain embodiments, the solid state DE proton conductor may be comprised of SiO₂ and exhibit characteristics of an electronic insulator, which makes it suitable as a solid state electrolyte. In certain embodiments, the natural DE may be hydrated, which may further improve the proton conductivity.

Also disclosed herein is a method of using DE as a proton conductor in various electrochemical applications, such as a fuel cell.

In one embodiment of a fuel cell application as disclosed herein, a hydrogen anode may be separated from an oxygen cathode by an electrolyte comprising DE. Protons are generated by the hydrogen anode through separation of protons and electrons by a catalyst, such as palladium or platinum. The separated protons may then be conducted through the DE electrolyte to the oxygen cathode. Electrons, which do not pass through the DE electrolyte, may be used to power a load. After the current generated from the load has been collected, the electrons may combine with protons and oxygen in the cathode to form water. In certain embodiments, the DE electrolyte may be hydrated within the fuel cell to increase proton conductivity.

Another embodiment disclosed herein is a gas sensor. In a gas sensor application, an ionization electrode and a reference electrode may be separated by a DE proton conductor as disclosed herein. The ionization electrode may decompose a gas, such as hydrogen, present in the ambient atmosphere to produce protons and electrons. The DE proton conductor may then conduct the protons to the reference electrode. In certain embodiments, the ionization electrode and the reference electrode may be short-circuited and connected via a low-impedance load. The current created as a result of the load may be measured as being indicative of the concentration of the relevant gas in the ambient atmosphere. In certain embodiments, the electrochemical potential difference created between the two electrodes may be measured to determine the gas concentration.

Another embodiment disclosed herein is a humidity sensor. In a humidity sensor application, the absorption of water into the sensor structure may cause changes in proton conductivity to a DE proton conductor used to separate an anode and a cathode. Those changes may be measured to indicate the amount of moisture in the atmosphere.

In another embodiment disclosed herein, DE may be used as a proton conductive filler in a polymer membrane.

Further features and embodiments of the present disclosure will become apparent from the description and the accompanying drawings. It will be understood that the features mentioned above and those described hereinafter may be used not only in the combination specified but also in other combinations or on their own, without departing from the scope of the present disclosure. It will also be understood that the foregoing background, summary, and the following description of the systems consistent with the principles of the present disclosure are in no way limiting on the scope of the present disclosure and are merely illustrations of an embodiment of the present disclosure.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a graph illustrating changes in proton conductivity of an exemplary DE proton conductor in the form of a water soaked pellet over time.

FIGS. 2A and 2B illustrate impedance spectra of an exemplary DE proton conductor before and after hydration.

FIG. 3 is a graph illustrating changes in proton conductivity of an exemplary DE proton conductor in the form of a water soaked bulk material over time.

FIG. 4 is a graph illustrating proton conductivity of an exemplary DE proton conductor over a range of temperatures.

FIG. 5 is an illustrative fuel cell utilizing an exemplary DE proton conductor as an electrolyte.

### DETAILED DESCRIPTION

The following detailed description refers to the accompanying drawings. Wherever possible, the same reference numbers are used in the drawings and the description thereof. While several exemplary versions and features of the invention are described herein, modifications, adaptations and other implementations are possible, without departing from the spirit and scope of the invention.

As disclosed herein, natural diatomaceous earth products are configured as proton conductors for fuel cells and other electrochemical applications, including, for example, humidity sensors, gas sensors, and pH sensors. Also disclosed herein is a proton-conductive polymer membrane comprising DE. The DE products used in such applications may exhibit high proton conductivity at room temperature due to their unique porous structures. In certain embodiments, the natural DE may be hydrated, which may further improve proton conductivity.

Suitable DE proton conductors according to embodiments disclosed herein may be prepared from a natural diatomite crude material. The DE proton conductors may be formed by, for example, cutting from diatomaceous crude to form a plate. Alternatively, diatomaceous crude may milled into a powder. In certain embodiments, a diatomaceous powder is pressed into pellets.

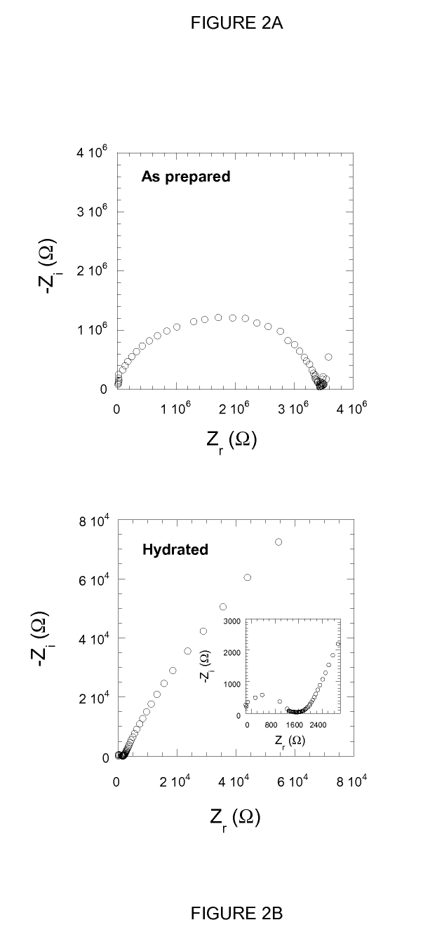

Proton conductivity may be determined by an impedance analysis. In this analysis, a cell is formed by sandwiching the exemplary DE proton conductor between two “blocking” electrodes. A frequency response analyzer measures the impedance from the imaginary (Zᵢ) and real (Zᵣ) parts at various frequencies. The electrolyte resistance may be determined by analyzing the response in an imaginary (-Zᵢ) and real (Zᵣ) plane based on an equivalent circuit comprising a resistor R (electrolyte) in parallel with a frequency-dependent capacitance C and their associated electrode-electrolyte interface impedance. For example, a semicircle at higher frequencies in the imaginary (-Zᵢ) and real (Zᵣ) plane corresponds to resistance-capacitance RC elements, while an inclined spike at lower frequencies corresponds to electrode-electrolyte interface. See e.g., FIG. 2. In the present disclosure, the impedance of the DE proton conductors disclosed in the examples that follow are represented, similar to other ionic conductors, by a resistor R in parallel with a frequency-dependent capacitance C and the electrode-electrolyte interface impedance.

The proton conductivity of DE proton conductors may be given in the form of d/AR, where d represents the sample thickness, A represents the area of the sample, and R represents the resistance obtained from the impedance data as described above. The impedance of DE proton conductors may be measured at frequencies ranging from 0.01 Hz to 10 MHz, using a frequency response analyzer, such as a SOLARTRON 1260 frequency response analyzer. To achieve the appropriate size and form of the DE proton conductors, the diatomite crude material may either be cut into a plate of suitable size or milled into a fine powder and then pressed into pellets. In certain embodiments, gold contacts may be deposited onto the faces of the plates or pellets by sputter deposition. While gold contacts are used in connection with the exemplary DE proton conductor samples in this application, those skilled in the art will appreciate that other suitable contact materials such as platinum (Pt), nickel (Ni), and vanadium (V) may be used without departing from the spirit of the present invention. Impedance measurements may, for example, be taken at a temperature ranging from 22° C. to 45° C.

As is disclosed herein, DE proton conductors of various shapes, for example, as pellet and plates of various sizes, and in both dried and non-dried forms, are capable of conducting protons at room temperature. The proton conductivity of all such DE proton conductors may be increased through hydration, for example, by soaking in water. The proton conductivity of the hydrated DE proton conductor may be comparable to that of hydrated zeolite, for example, as shown in U.S. Pat. No. 4,495,078, disclosing zeolite as a proton conductor for fuel cells.

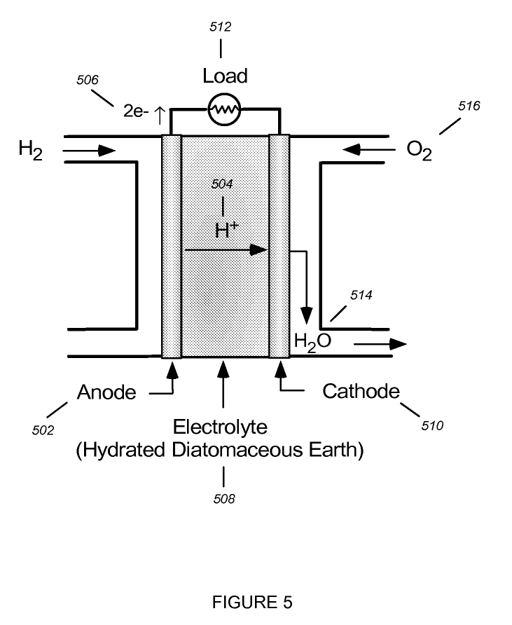

An illustrative fuel cell consistent with the present invention, which uses a DE proton conductor as a solid state proton electrolyte is shown in FIG. 5. In this figure, protons are generated by a hydrogen anode 502, for example, through separation of protons 504 and electrons 506 by a catalyst. The separated protons 504, being of sufficiently small size to pass through the DE electrolyte 508, are conducted through the DE electrolyte 508 to an oxygen cathode 510. Electrons 506 cannot pass through the diatomite electrolyte 508, and therefore must seek a path through the load 512, which thus generates a current. After the current generated has been collected, the electrons 506 combine with protons 504 and oxygen 516 at the cathode 510 to form water 514.

As mentioned above, in certain embodiments the DE proton conductor may be hydrated, and thus may have superior proton conductivity when compared to a dry DE proton conductor. Therefore, DE electrolyte 504 may be hydrated within the fuel cell using known hydration methods, for example, those methods described in U.S. Pat. No. 6,015,633. In one embodiment, a flow field plate may be implemented within the fuel cell to transport water to fuel the reactions and hydrate the proton conductor.

As disclosed herein, the use of a DE proton conductor is not limited to fuel cells. For example, the DE proton conductor may also be used in a solid state proton conductor gas sensor. In one embodiment, the gas sensor may comprise, for example, an ionization electrode and a reference electrode, where the electrodes are separated by a DE proton conductor as disclosed herein, in a manner similar to the fuel cell arrangement shown in FIG. 5. The ionization electrode or anode may decompose hydrogen or like gas present in the atmosphere to produce protons and electrons as described above in connection with anode 502. The DE proton conductor may then conduct the protons to a reference electrode acting as the cathode 510 described in connection with FIG. 5. At the reference electrode, the protons may react with the oxygen in the atmosphere to release water.

In certain embodiments, the ionization electrode and the reference electrode may be short-circuited, for example, on an integrated part of the sensor or on an attached sensor. The electrodes may be connected via a low-impedance load, for example in the manner of load 512 shown in FIG. 5. The impedance of the load should be lower than the impedance of the DE proton conductor, for example, the impedance of the load may be 25% or any other suitable lower percentage of the impedance of the DE proton conductor. The current created as a result of the load may be measured as being indicative of the concentration of the relevant gas in the atmosphere.

The above-described gas sensor may detect changes in concentrations of gases such as hydrogen, arsine, and silanes, as well as other gases that readily decompose to produce protons. The detection of those gases has a low dependence on humidity because water is not used for proton production. When the gas sensor is used to detect gases such as carbon monoxide, sulfur dioxide, nitrogen oxides, and other such gases that may react with water vapor to produce protons, water may be added to the system through humidity.

In certain embodiments of the gas sensor, an alarm-triggering concentration level or levels for a gas being measured may be predetermined. Once the measured level reaches the predetermined alarm-triggering level, the gas sensor may be set off or otherwise triggered to provide notice that the gas in the atmosphere has reached the predetermined level.

In another embodiment, the DE proton conductor may be used in a solid state humidity sensor. In one embodiment, the DE proton conductor may be incorporated into a humidity sensing element in which the humidity is measured based upon the reversible water absorption characteristics of the DE proton conductor. For example, the absorption of water into the sensor structure may cause a number of physical changes in the DE proton conductor. These physical changes may be transduced into electrical signals associated with the water concentration in the DE proton conductor and the atmosphere.

In one embodiment the DE proton conductor, which may exhibit superior proton conductivity at higher hydration levels, has its proton conductivity measured after absorption of moisture at various humidity levels. The measured proton conductivity may be indicative of the amount of moisture in the ambient atmosphere.

In one embodiment, DE may be used as a proton-conductive filler incorporated into a polymer membrane, such as a permeable ion-exchange membrane. Such a membrane may comprise part of a proton conducting device, such as a fuel cell, to physically separate the anode from the cathode while serving as an electrolyte. In this embodiment, DE may be added to a membrane as a filler, thereby enhancing the membrane's proton conductivity and improving the mechanical strength of the membrane.

It should be understood that the DE proton conductor may be incorporated in a variety of electrochemical applications in which an electrolyte is desirable. While the present invention has been described in connection with various embodiments, many modifications will be readily apparent to those skilled in the art. Accordingly, embodiments of the invention are not limited to the embodiments and examples described herein.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contain certain errors necessarily resulting from the standard deviation found in their respective testing measurements.

### EXAMPLES

In the examples that follow, the Mexican crude from which the exemplary DE proton conductors were prepared comprises about 96 wt % SiO₂, 3 wt % Al₂O₃, 0.5 wt % Fe₂O₃, 0.2 wt % MgO, 0.2 wt % CaO, and trace concentrations of other metallic elements. Proton conductivity was measured by the impedance analysis disclose above. In this regard, impedance was measured at frequencies ranging from 0.01 Hz to 10 MHz using a SOLARTRON 1260 frequency response analyzer. The natural DE crude material was cut into small plates or milled into fine powders and then pressed into pellets. Gold contacts were deposited on the faces of the plates or pellets by sputter deposition. The plates/pellets were then sandwiched between platinum plates and pressed against a heater block inside a small vacuum chamber, with a thermocouple attached to the heater block near the plate. High purity argon was then circulated through the chamber during impedance measurement. Impedance measurements were taken at temperatures ranging from 22° C. to 45° C.

### Example 1

A natural diatomite crude was cut into a 11.8 mm×13.1 mm×4.3 mm plate. The plate was dried at 100° C. for a few hours before being sputtered with gold contacts. The proton conductivity of the plate was measured by impedance at 22° C. and was 1.09×10⁻⁸ S/cm (siemens/centimeters).

### Example 2

A natural diatomite crude was cut into a 12.6 mm×13.3 mm×4.2 mm plate and sputtered with gold contacts. The proton conductivity of this example measured by impedance at 22° C. was 4.52×10⁻⁷ S/cm.

### Example 3

A natural diatomite crude was milled into fine powders. The fine powders were then cold pressed into a pellet measuring about 0.4 mm thick by 7.8 mm in diameter. The pellet was dried at 100° C. for a few hours before being sputtered with gold contacts. The proton conductivities of this example measured by impedance were 2.39×10⁻⁸ S/cm at 22° C.; 9.85×10⁻⁹ S/cm at 35° C.; and 3.99×10⁻⁹ S/cm at 45° C. It is theorized that the decrease of proton conductivity with increasing temperature may be due to the loss of water in the diatomite.

To increase proton conductivity, this sample was hydrated by soaking the diatomite pellet in water. The proton conductivities for the hydrated sample at 22° C. were 5.54×10⁻⁵ S/cm measured immediately after hydration, 2.39×10⁻⁸ S/cm measured 15 minutes after hydration, and 2.26×10⁻⁸ S/cm measured 30 minutes after hydration. It is theorized that the decrease of proton conductivity with time may be due to the loss of water in the diatomite pellet.

FIG. 2 illustrates the typical impedance spectra of this example before and after hydration. The electrolyte and the electrode-electrolyte interface effects are evident by the presence of a semicircle at higher frequencies and an inclined spike in the complex imaginary (-Zᵢ) and real (Zᵣ) plane.

### Example 4

A natural diatomite crude was milled into fine powders. The fine powders was then cold pressed into a pellet measuring about 0.4 mm thick by 7.9 mm in diameter, and the pellet was sputtered with gold contacts. The proton conductivity of this example measured by impedance was 1.87×10⁻⁷ S/cm.

### Example 5

A natural diatomite crude was cut into a 7.3 mm×10.3 mm×3.5 mm plate and sputtered with gold contacts. The proton conductivity of this example measured by impedance was 2.02×10⁻⁹ S/cm at 22° C. To increase proton conductivity, this sample was hydrated by soaking the diatomite plate in water. The proton conductivities measured at 22° C. for the hydrated sample were 2.71×10⁻⁵ S/cm measured immediately after hydration, 2.43×10⁻⁵ S/cm measured 15 minutes after hydration, 2.04×10⁻⁵ S/cm measured 30 minutes after hydration, 7.86×10⁻⁵ S/cm measured 45 minutes after hydration, 1.58×10⁻⁵ S/cm measured 60 minutes after hydration, and 2.12×10⁻⁹ S/cm measured 960 minutes after hydration.

Table 1, below, summarizes the results of Examples 1-5.

TABLE 1
Proton Conductivity at Room Temperature (22° C.)

| | Sample Size and | Proton Conductivity |
|---|---|---|
| Example No. | Condition | (Siemens/cm) |
| Example 1 | 11.8 mm × 13.1 mm × 4.3 mm | 1.09 × 10⁻⁸ |
| | dried plate | |
| Example 2 | 12.6 mm × 13.3 mm × 4.2 mm | 4.52 × 10⁻⁷ |
| | non-dried plate | |
| Example 3 | 0.4 mm in thickness and | 2.39 × 10⁻⁸ |
| | 7.8 mm in diameter | |
| | dried pellet | |
| Example 4 | 0.4 mm in thickness and | 1.87 × 10⁻⁷ |
| | 7.9 mm in diameter | |
| | non-dried pellet | |
| Example 5 | 7.3 mm × 10.3 mm × 3.5 mm | 2.02 × 10⁻⁹ |
| | non-dried plate | |

### Example 6

Attempts were made to increase the proton conductivity of DE by increasing the moisture content of the samples.

Initially, steam was used to hydrate sample 3 from Example 3. Specifically, sample 3 was placed in a test tube inside a beaker filled with boiling water, where the pellet in the test tube was not in direct contact with the water in the beaker. A measurement of proton conductivity post steaming indicated that the proton conductivity of the pellet had decreased. It is theorized that this decrease may be due to the elevated temperature during steaming, which may have caused more evaporation of the moisture in the pellet than the addition of moisture to the pellet from the steam.

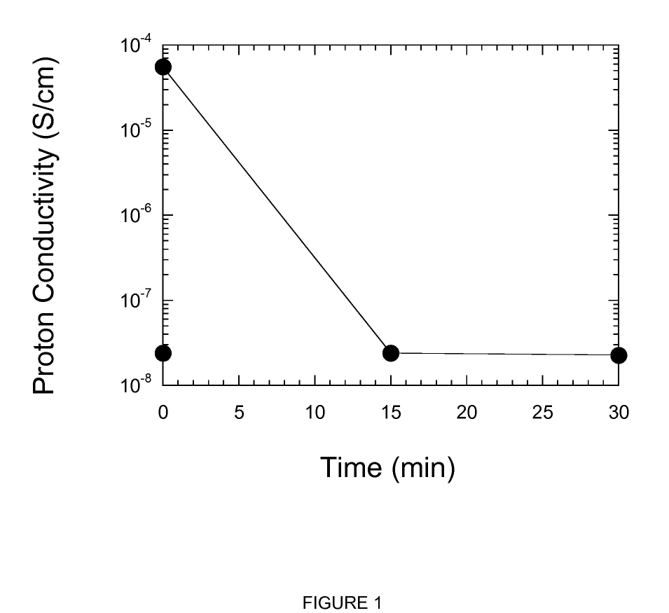

A second hydration method was then employed, in which sample 3 was directly immersed and soaked in water. Measurements of proton conductivity post soaking indicated that this method increased the proton conductivity of sample 3. FIG. 1 shows proton conductivities of sample 3 measured over a period of time post hydration.

As shown in FIG. 1, proton conductivity of sample 3, at a value of 5.54×10⁻⁵ S/cm, was at its highest immediately after soaking or hydration. This value decreased to 2.39×10⁻⁸ S/cm after 15 minutes and then decreased further to 2.26×10⁻⁸ S/cm after 30 minutes. It is theorized that this stepped decrease in proton conductivity over time corresponds to loss of moisture in the pellet from air exposure post hydration.

Exemplary impedance spectra of sample 3 before and after hydration is illustrated in Table 2, below. Moreover, FIGS. 2A and 2B show sample 3's impedance spectra prior to hydration and post hydration.

The electrolyte resistance of sample 3 was determined by analyzing the response in a complex imaginary (-Zᵢ) and real (Zᵣ) plane based on an equivalent circuit comprising a resistor R (electrolyte) in parallel with a frequency-dependent capacitance C and their associated electrode-electrolyte interface impedance. A semicircle at higher frequencies in the complex imaginary (-Zᵢ) and real (Zᵣ) plane corresponds to resistance-capacitance RC elements while an inclined spike at lower frequencies corresponds to electrode-electrolyte interface. In FIG. 2, Zi is the imaginary part and Zr is the real part of the complex impedance. The impedance curves shown in FIG. 2 confirms the observations made and discussed above in connection with the hydration of sample 3. Specifically, the impedance corresponds to samples 3's increase in proton conductivity post hydration.

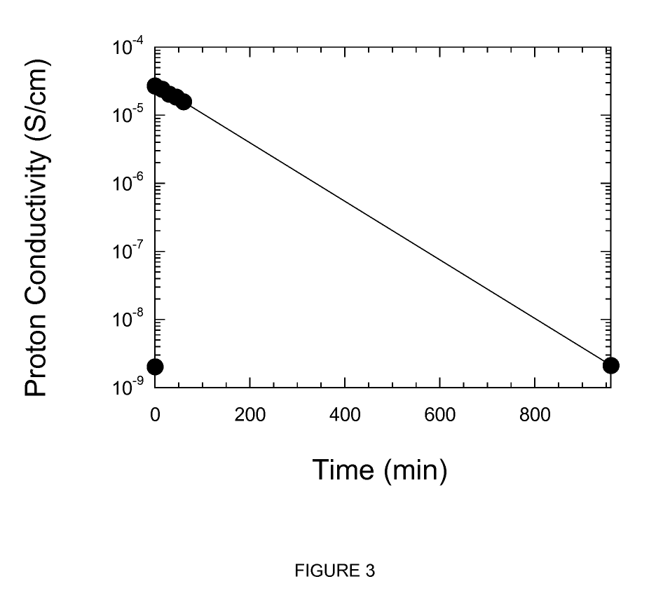

In addition to hydration of sample 3 as described above, the non-dried plate sample 5 was also subject to hydration and testing to provide a comparison to the results of sample 3, as shown below is Table 2. Similar to the treatment of sample 3, sample 5 from Example 5 was directly immersed in water until fully hydrated. A graph representing proton conductivities of sample 5 measured at various time intervals post hydration is shown in FIG. 3.

As shown in Table 2, immediately after hydration, the proton conductivity of sample 5 was measured at 2.71×10⁻⁵ S/cm, an increase from proton conductivity measured prior to hydration at 2.02×10⁻⁹ S/cm. This was, however, still less than the corresponding proton conductivity of hydrated sample 3.

At fifteen minutes after hydration, the proton conductivity of sample 5 was measured at 2.43×10⁻⁵ S/cm, a slight decrease from the proton conductivity level of sample 5 immediately post hydration. To the contrary, sample 3's proton conductivity dropped from 5.54×10⁻⁵ S/cm to 2.39×10⁻⁸ S/cm, which was the same level as sample 3's proton conductivity measured prior to hydration.

Assuming that the improvement in proton conductivity is due at least in part to the increase in moisture in the pellet of sample 3, the decrease to the pre-hydration level after 15 minutes may suggest that the moisture introduced by hydration was lost within that short interval. Accordingly, the loss of proton conductivity in sample 5 within the 15 minute interval may suggest that the plate of sample 5 is more efficient in retaining moisture as compared to the pellet of sample 3. This conclusion was further evidenced by the proton conductivity measurement of sample 5 at 30 minutes after hydration. After 30 minutes, sample 5's proton conductivity was reduced to 2.04×10⁻⁵ S/cm, which is still higher than its pre-hydration level of 2.02×10⁻⁹ S/cm. In summary, the larger plate of sample 5, once hydrated, demonstrates longevity in increased proton conductivity, while the proton conductivity of smaller-sized pellets of sample 3 exhibits a spike increase immediate post hydration, but soon dropped back to pre-hydration level with quick moisture loss.

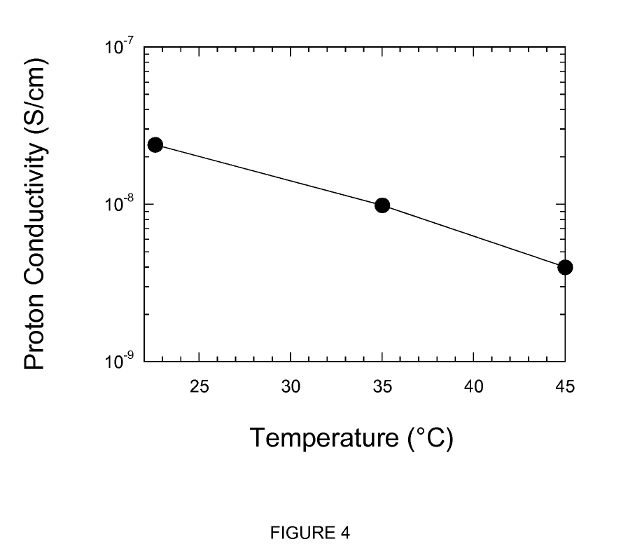

It has been noted that the above proton conductivity evaluations are all performed at a room temperature of about 22° C. However, it has also been recognized that it is useful to determine the effect of elevated temperature on the DE proton conductor's proton conductivity. To determine this effect, sample 3 was subjected to elevated temperatures of 35° C. and 45° C., at which proton conductivity of the pellet was measured in the same manner as at room temperature. A graph illustrating the effects of temperature on the proton conductivity of sample 3 is shown in FIG. 4.

It may be seen from the graph that proton conductivity was the highest (2.39×10⁻⁸ S/cm) at room temperature. When the temperature was increased to 35° C., sample 3 showed a reduced proton conductivity of 9.85×10⁻⁹ S/cm. At 45° C., the proton conductivity is further reduced to 3.99×10⁻⁹ S/cm. This stepped decrease in proton conductivity as temperature increases is in reverse to the effect of hydration and, therefore, suggests graduate loss of moisture as temperature increases.

TABLE 2
Proton Conductivity of Hydrated Samples
at Room Temperature (22° C.)

| | Immediately | 15 Minutes | 30 Minutes |
|---|---|---|---|
| Example No. | After Hydration | After Hydration | After Hydration |
| Example 3 | 5.54 × 10⁻⁵ S/cm | 2.39 × 10⁻⁸ S/cm | 2.26 × 10⁻⁸ S/cm |
| (dried pellet) | | | |
| Example 5 | 2.71 × 10⁻⁵ S/cm | 2.43 × 10⁻⁵ S/cm | 2.04 × 10⁻⁵ S/cm |
| (non-dried | | | |
| plate) | | | |

1. A solid state proton conductor comprising diatomaceous earth.

2. The solid state proton conductor according to claim 1, wherein the diatomaceous earth is hydrated.

3. The solid state proton conductor of claim 1, wherein the diatomaceous earth is in the form of a diatomite plate.

4. The solid state proton conductor of claim 1, wherein the diatomaceous earth is in the form of a diatomite pellet.

5. A fuel cell, comprising:
a hydrogen anode;
an oxygen cathode; and
a diatomaceous earth proton conductor separating the hydrogen anode and the oxygen cathode, wherein the diatomaceous earth proton conductor conducts protons generated at the hydrogen anode to the oxygen cathode.

6. The fuel cell according to claim 5, wherein the diatomaceous earth proton conductor is hydrated.

7. The fuel cell of claim 5, wherein the diatomaceous earth proton conductor is in the form of a diatomite plate.

8. The fuel cell of claim 5, wherein the diatomaceous earth proton conductor is in the form of a diatomite pellet.

9. The fuel cell of claim 5, wherein the hydrogen anode is sputtered with gold.

10. A gas sensor, comprising:
an ionization electrode that decomposes a gas to form protons and electrons;
a reference electrode;
a diatomaceous earth proton conductor separating the ionization electrode and the reference cathode, wherein the diatomaceous earth proton conductor conducts protons generated at the ionization electrode to the reference electrode; and
a means for measuring the electrochemical potential difference produced in the diatomaceous earth proton conductor.

11. The gas sensor according to claim 10, wherein the diatomaceous earth proton conductor is in the form of a diatomite plate.

12. The gas sensor according to claim 10, wherein the diatomaceous earth proton conductor is in the form of a diatomite pellet.

13. The gas sensor according to claim 10, further comprising an alarm that notifies a user when a gas concentration exceeds a predetermined concentration.

14. A humidity sensor comprising:
a hydrogen anode;
an oxygen cathode;
a diatomaceous earth proton conductor separating the hydrogen anode and the oxygen cathode, wherein the diatomaceous earth proton conductor conducts protons generated at the hydrogen anode to the oxygen cathode; and
a means for measuring proton conductivity of the diatomaceous earth proton conductor.

15. The humidity sensor according to claim 14, wherein the diatomaceous earth proton conductor is in the form of a diatomite plate.

16. The humidity sensor according to claim 14, wherein the diatomaceous earth proton conductor is in the form of a diatomite pellet.
